(19) United States
(12) Patent Application Publication
(10) Pub. No.: US 2005/0111041 A1
(43) Pub. Date: May 26, 2005

(54) Rendering electronic presentations to printed surface

(75) Inventors: Matti Salmi, Tampere (FI); Jari Selenius, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/722,383

(22) Filed: Nov. 25, 2003

(51) Int. Cl. G06F 15/00

(52) U.S. Cl. 358/1.18; 358/1.12

(57) ABSTRACT

This invention relates to a method for printing an electronic presentation, wherein the method comprises steps for forming at least one printable output from said electronic presentation that comprises multiple events, by defining a temporal aspect of said events, whereby the printable output is formed based on said temporal aspect. The electronic presentation can be e.g. in the form of the multimedia message comprising different media elements, for example text, image, video, audio etc. The invention also relates to a system for printing such an electronic presentation and to a device for producing such a printable output. In addition the invention relates to a device module and to a computer program product. Invention also relates to a method for delivering a printed electronic message to a recipient.

### FIELD OF THE INVENTION

This invention relates generally to electronic presentations and particularly to printing such a presentation.

### BACKGROUND OF THE INVENTION

Multimedia messaging is a modern and prominent service used in mobile terminals. The multimedia messaging is part of evolution of mobile communication, wherein voice-based calls and text-based short messages are advanced into messaging of several different media types. Use of multimedia messages enables a variety of different services. The services are continuously developing due to different electronic applications. The multimedia capable terminals and services are gaining speed with the current introduction of camera phones in market

Although the electronic communication between terminals is effective, combining it with traditional communication results in significant market benefits. As one example a postcard service can be presented, where the user is capable of ordering an postcard via e.g. SMS (Short Message Service), WAP (Wireless Application Protocol), Internet from a service supplier, wherein a paper copy of said postcard is delivered to the recipient. One of the new services is a postcard service where the user sends an message to a service supplier via MMS (Multimedia Messaging Service) where in the service the message is printed as physical postcard and delivered to the recipient. The content of the message can then be e.g. a self-photographed image.

The presentation of the multimedia message is controlled by SMIL (Synchronized Multimedia Integration Language), which is a mark-up language akin to HTML (Hyper-text Mark-up Language) and XML (Extensible Mark-up Language). SMIL presentation is a mandatory component of the multimedia messages. The SMIL is used for programming even complex multimedia presentations to be composed and presented to the end user. SMIL defines a structure for the presentation comprising a multimedia files, which can be text, sound, images, video, animation, etc. or a combination thereof. Layout of a SMIL-presentation is divided into different regions, each of which can be contained of different multimedia content. The structure resembles that of a slide presentation application or similar presentations. The SMIL presentations contain spatial aspects (e.g. where an image is located on the display), temporal aspects (e.g. how long an image is visible on its location) and interaction aspects (e.g. by actuation of which key an image becomes visible).

The need for printing images via MMS is increasing. The service suppliers offer general printing services, such as photo kiosks for printing them. The user sends the image through MMS to the service supplier who prints it to the paper. When the paper photos are ready the service supplier informs the customer e.g. by SMS that the photos are ready/available to be picked up. Applicant's former publication WO 01/97504A1 “Messaging service system and a method to be performed in such a system” presents one example of a method for printing images via MMS.

If the presentations are rendered to a fixed, unalterable surface, e.g. printed to the paper, some of the presentation components are not applicable, especially those that control the temporal and interaction aspects of the presentation. This problem arises also if one wants to print out a multimedia message. The problems to be solved are how the necessary information is extracted from the message and how the images are placed into the print.

### SUMMARY OF THE INVENTION

The present invention defines how an electronic presentation, e.g. multimedia message using e.g. SMIL mark-up language can be rendered to a printed surface. The invention also describes how the current invention is applied to an older MMS SMIL version.

One aspect of the current invention is to form at least one printable output, such as a variable-sized paper, a postcard, a facsimile, from an electronic presentation, e.g. multimedia message, comprising at least one event. An “event” in this description corresponds to a time the object appears in the presentation, in other words, an onset of the object. A term “object” refers to any multimedia element being delivered in a message carrying multimedia elements. Multimedia element can be an image element, a text element, an interaction element, a video element, an audio element etc.

The printable output can be formed by defining a temporal aspect of said at least one event, whereby said printable output comprising said event, is formed based on that definition. This means that the electronic presentation is analyzed in time, whereby as many events there are (multimedia) objects in the message are analyzed.

Additional feature of the current invention is to study a spatial aspect of each event by defining the location of the event in relation to the layout of the presentation and then combine events into one output, if their layout locations differ from another, and otherwise keep them on separate outputs. The events locating substantially on the same layout location are further studied by their temporal aspect, and that event, which is temporally closer—than those other events sharing the same layout location—to the combined events is also added to the combined output. Sometimes, if the location of the objects matches, but the space required by the objects differs, wherein the objects are partially overlapping, further study may be done. In this case the temporal study, as mentioned above, can be done, wherein the temporally closer object is combined. It is also possible to combine the temporally further but bigger object.

In conclusion, there will result, depending on the use, one or many outputs which are then printed. The printed output, referred as printout, can be a paper printout or a file printout. The layout of one output can be formed similarly to the presentation and scaled to the size of the printout. Naturally, it is also possible to place several outputs on one or many printout. FIG. 1 recapitulates the principle of the invention.

The invention relates to a method for printing an electronic presentation, a device for use in a printing of an electronic presentation as well as a system for printing of an electronic presentation. The invention relates also to components for forming at least one printable output from an electronic presentation, components such as a device module and a computer program product. In addition the invention relates to a method for delivering a print of an electronic presentation to a recipient.

The description mentions electronic presentation as an embodiment of the invention. Electronic presentation can be a multimedia message or other multimedia presentation being processed in a mobile device or in other data processing device and being composed of different multimedia elements. The electronic presentation is not limited to media types (image, text, video, audio).

Electronic presentation such as multimedia messages (e.g. SMIL presentation) with spatial, temporal and interaction aspects may not create same presentation when printed. The way how spatial aspects in the presentations are converted to printed surface may also be confusing to the end-user. However having a set of clear rules how a presentation is rendered to a printed page enables manufacturers to optimize products and guide end-users especially in case when messages are created specifically for printing services. The current invention is for presenting these rules.

The invention can also be utilized when considering interoperability of the multimedia messages of different versions. This is more discussed at the end of the description.

### DESCRIPTION OF THE DRAWINGS

A better understanding of the invention may be obtained from the following considerations taken in conjunction with the accompanying drawings, which are not meant to restrict the scope of the invention in any way. Further objects and advantages of the invention are also considered in the description. The invention itself is defined with particularity in the claims.

FIG. 1 illustrates the principle of the current invention,

FIG. 2 illustrates a simplified structure of an multimedia message, consisting of regions,

FIG. 3 illustrates time axis formed of the events of the message,

FIG. 4a-d illustrates temporal events of the message figuratively and in principle,

FIG. 5a-b illustrates very principled flow charts of embodiments of the method according to the invention,

FIG. 6 illustrates very principled a device according to the invention, and

FIG. 7 illustrates very principled an medium printed from the electronic device.

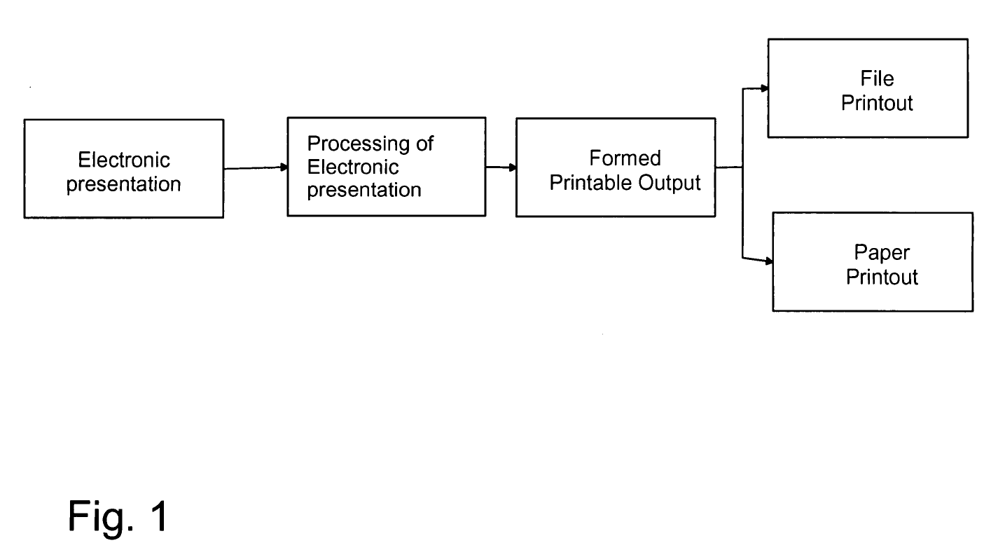

### DETAILED DESCRIPTION OF THE INVENTION

This invention is primarily addressed to the electronic presentation, and to the mark-up language used in such. The description discusses about multimedia messages as examples of the electronic presentation, but it should be noticed that multimedia messaging (MMS) is a way of transferring presentations between devices wirelessly, and the invention is not limited to that transfer method. Printable outputs of electronic messages can be formed in a mobile device but also in some other data processing device, and they can be printed though a wireless network, through a cable, through a personal computer or through any other link to the printing device. It should be also noticed, that outputs can temporally be also printed only to file stored in some memory means.

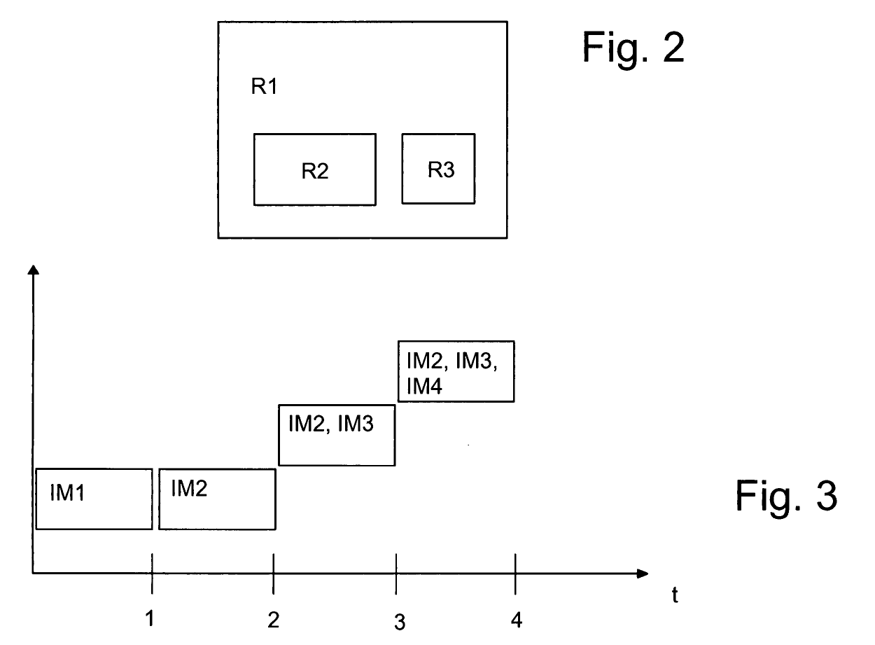

An example of mark-up language used in multimedia messaging (e.g. 3GPP) is SMIL 2.0, but it should be noticed that the mark-up language can be newer versions of SMIL or some other mark-up language, that has similar features than discussed here. FIG. 2 illustrates the basic structure of an electronic message, which is similar to the basic structure of SMIL presentation. Similar to the HTML or XML, SMIL uses tags where the information of the presentation is set. The <layout> element consists information about the presentation and presents <root layout> which defines how the presentation is showed on the display and what is the size of the layout. The layout locations, as regions (shown in FIG. 2) R1-R3 define where in the root the presentation objects actually occur. The description of the region is made by attributes of which <id> is the identification of the region, <title> gives information about the region, <left>, <top>, <width> and <height> define the location of the region compared to the root. It is obvious that presentation is not limited to three regions R1-R3, as well as the invention is not limited to three regions R1-R3. Above-mentioned regions R1-R3 are for the sake of clarifying.

The <body> tag in SMIL contains the presentation objects in more detail, e.g. a media type of the object. The media types are <text>, <img>, <audio>, <video>. For the objects further details such as the “region”, “src”, “type” and “dur” are provided. “Region” defines the region in the message layout, where the object is shown, “type” defines the media type (for example MIME-type) for the object, “src” defines the source (e.g. URL) and “dur” defines the duration of the presentation. For example, <img region=“Region 1” src=“images/image1.gif type=“image/gif” dur=“10s”/> describes that image1 (media type is image) is shown in the Region1 for 10 seconds. It should be noticed that in the description only the images are discussed as media types, but in real situation objects can be any media such as text, image, video, and audio.

At first when forming a printable output from the electronic presentation according to the invention, the irrelevant, those that cannot be printed, objects e.g. interaction elements as well as those relevant multimedia elements which are rendered as a result of interaction are removed from the presentation. Other multimedia elements (e.g. sound media) can also be removed, if they do not have corresponding printable version or if they are just not wanted to be left. But it should be noticed that e.g. sound file can be converted into a text- or an image-file, especially when the sound file is known sound such as ring.wav or cuckoo.wav or the tag has information of the sound (e.g. boo.wav ALT=“Scared?”). The sound files can be replaced e.g. by defining the conditions for it. The condition can, for example, be defined by a switch-sentence:

<switch>

<audio src=“cuckoo.wav” device=“mobile” />
<img src=“bird.gif” device=“printer” />

</switch>

, where it is first checked whether the device supports audio-files. If the device is a printer that does not support audio, the element is changed into a picture of bird.

Continuous or streamed media (e.g. animation or video) can be converted to non-continuous media when applicable, or removed. The conversion can be made for example by choosing one (first, last or one between) video frame and converting it to still image of same size.

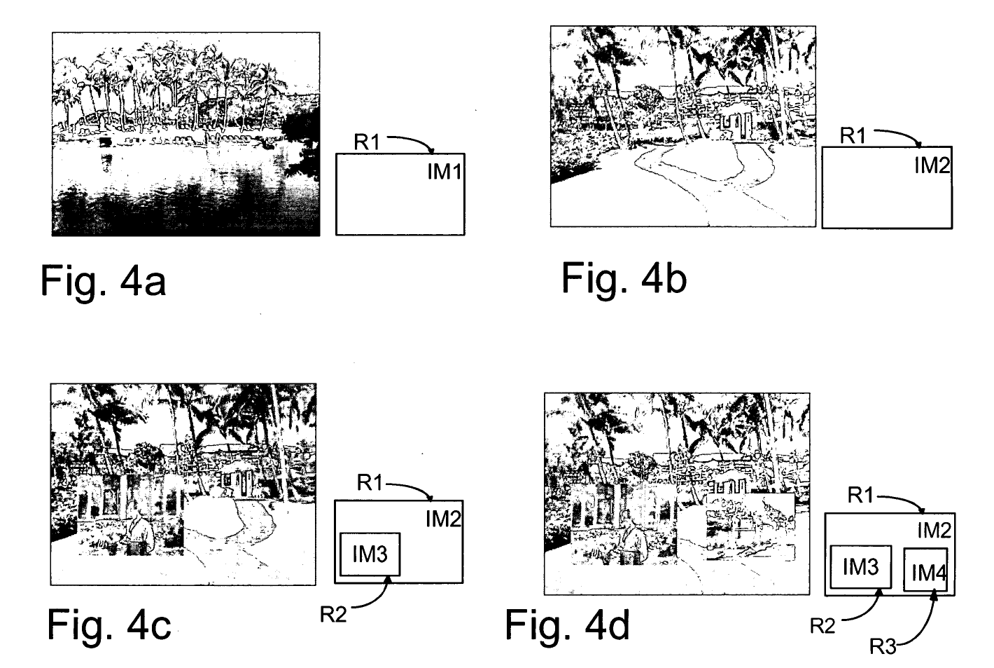

When the presentation is “cleaned”, temporal aspects of the presentation are studied by means of a time axis. One example of the time axis is shown in FIG. 3. Here the time-axis represents events of the message in time t. At the beginning (t=1) only the first image IM1 is displayed in the message. Next (t=2), the second image IM2 is displayed in the same region as the first image and the first image IM1 is not shown. After this (t=3), the third image IM3 is displayed with the second image IM2 and then (t=4) the fourth image IM4 is displayed with the third IM3 and the second image IM2, because they all IM3, IM4, IM2 use different regions. FIGS. 4a-4d represent the phases of the displays. Each of the FIG. 4a-4d show on the left side from the viewer a figurative display and on the right side from the viewer a display in principle. A first image IM1 is displayed in region R1 (3a), a second image IM2 is displayed also in region R1 (3b) and the first image is not shown anymore. A third image IM3 is displayed in region R2 (3c) and a fourth image IM4 is displayed in region R3 (3d). Each temporal event (appearance of an object) on time axis creates a new printable output. In other words each formed printable output consists of one temporal event.

When the time axis analysis is done, the resulting events are studied. All events without spatial overlap (e.g. overlap of two images) can be combined into same output. In the situation of FIGS. 3 and 4, this means that the first and second events IM1, IM2 cannot be combined, since they use the same region R1. They need to be printed separately. The third and the fourth events IM3, IM4 are combined into same output, since they have images in different regions R2, R3. The second and the combined last events are combined, since they use different regions for the images. The reason why the first event is not combined with the last events is because it is temporally further to them than the second one. However it is obvious that the combination not necessarily need temporally closer events. Depending on the situation, the combined event can be chosen.

The resulting one or many printable outputs (combined/separated) are then printed. Printing is done, depending on a print device and a use, as multiple printouts or as a single printout. The multiple outputs can be scaled to fit adjacent slots in the printout, single output can be scaled to fill the printout or outputs can be printed as they are. It is obvious that the invention discussed here is not limited to printing, the outputs can be printed in any possible way.

The above-discussed method according to the invention can be applied also to lower versions of SMIL. As an example of such version is MMS SMIL or other relevant Open Mobile Alliance (OMA) standard messages or other corresponding multimedia messages, which are comprised of “slides”. At first the MMS message to be printed is analyzed and the irrelevant elements for printing (sometimes e.g. AMR- or MIDI-sound; MMS streaming elements) can be removed. The video objects can be converted to image objects (e.g. GIF, JPEG) of the same frame size. The selection of which frame is converted varies depending on the situation. The first or the last frame can be converted, but also any frame, or any set/combination of frames between them can be converted. Also it is possible to convert frames for example in every minute or in any other time interval. The originator of the message may define the frames that are preferably used for converting. The converted video images are from then on processed as images. Each slide of MMS SMIL presentation can be considered to be one event as in the 3GPP SMIL, and each results in new printable output. Since MMS SMIL defines only one image and text region, all images and texts are fully spatially overlapping. Thus the page combination may not be done. Due to this, the slides of MMS SMIL presentation will be printed either into/to multiple printouts or as adjacent slots in a single printout, depending on the use and the print device.

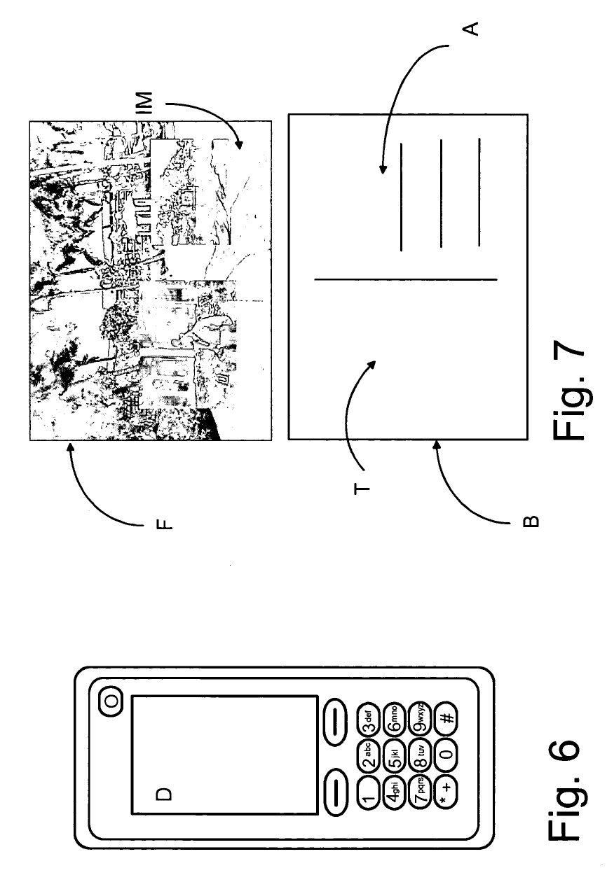

The basic idea behind the use of the invention is that the recipient of the multimedia message prints the message out or that the creator of the electronic presentation prints the presentation out. One example is that the recipient is a service provider, e.g. a postal service provider, whereupon a user (referred here by “sender”) of a mobile terminal, when wanting to send a postcard to someone, sends a multimedia message to the service provider. At first the sender composes a multimedia message with, for example, desired image and text, and sends the message to the service provider who prints the message out according to the invention and delivers the printout, such as a postcard shown in FIG. 6, to the recipient. In this situation the sender can define e.g. which frames are converted into images and printed or how a sound-file is replaced. A background B of the postcard can comprise of an text field T, an address field A for the address of the recipient. The foreground F of the postcard can comprise the multimedia message IM sent.

Another example would be that the recipient is just a normal user, who receives a multimedia message that he/she wants to print out. In this situation the recipient him-/herself can define the print options, such as frames to be converted and printed or how a sound-file is replaced. Also, the creator of an electronic presentation can print the presentation out. In both cases the printing can be done by means of a printing service, a personal printing device, a personal computer, etc.

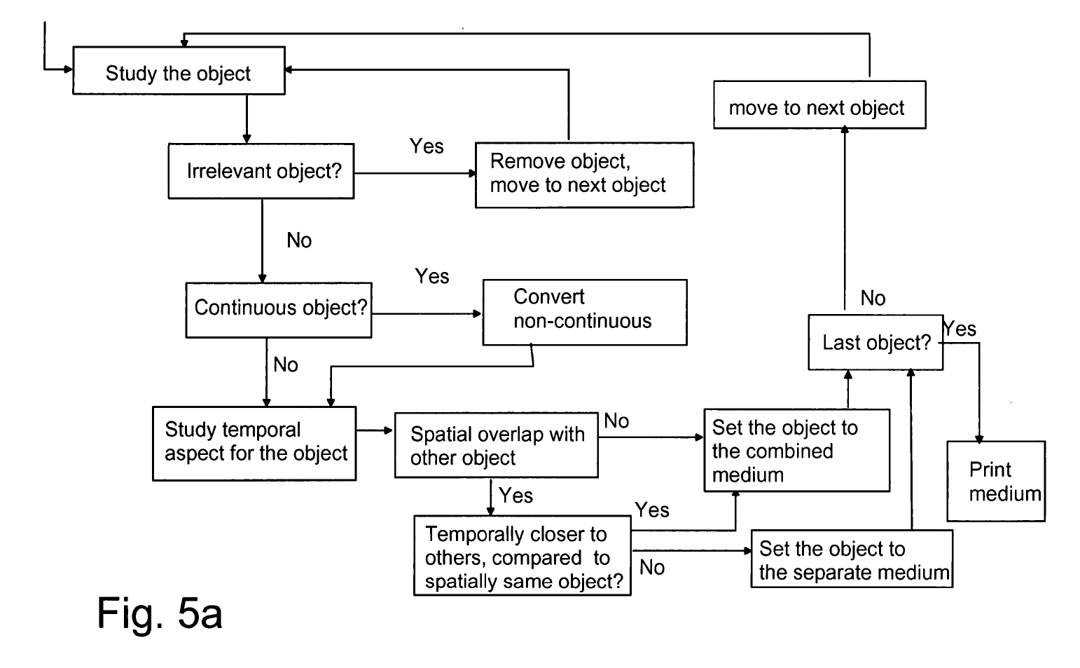

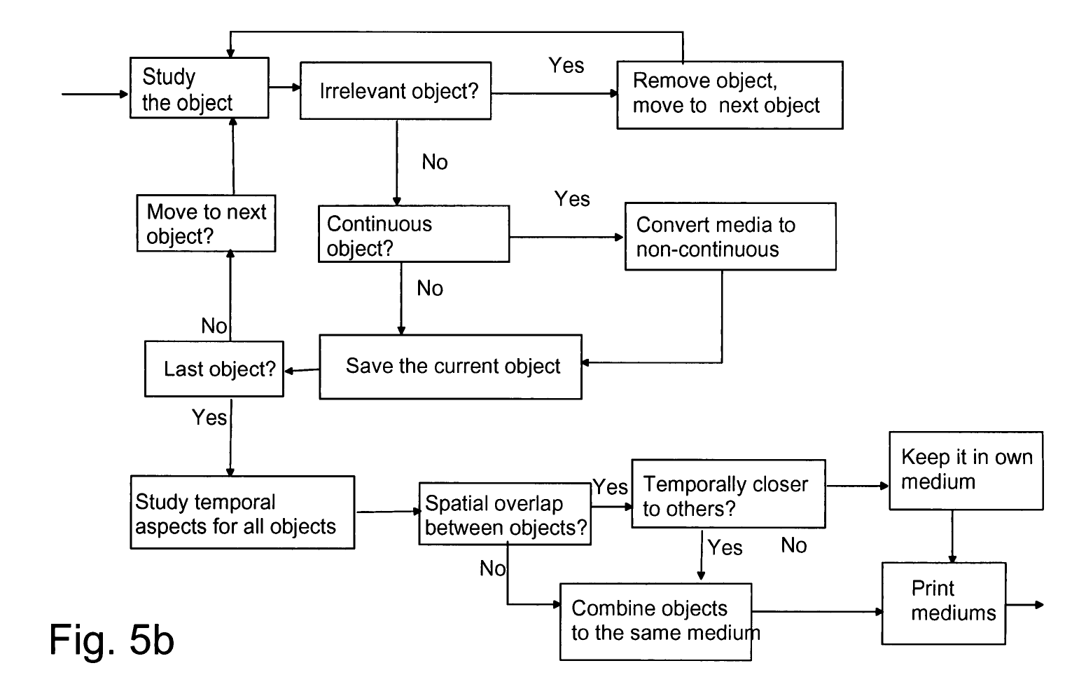

The steps of a method is illustrated in a very principled manner in FIGS. 5a and 5b. The main difference between FIGS. 5a and 5b is an order of a performance. In the method of FIG. 5a only one object is processed in time, after which the others are processed. In the method of FIG. 5b all the objects are processed and after that they are all combined or separated. These figures are just examples of how the method according to the invention can be carried out. These examples should indicate, that different orders for performance can exist and that the invention is not limited to them.

The method according to the invention is carried out by a computer program in an electronic device. The electronic device is, for example, a mobile device with communication capabilities. An example of such a device is shown in FIG. 6. The device can be a mobile phone, communicator, PDA (portable digital assistant) or similar comprising also means, e.g. a display D, for reading/viewing the message. The mobile device can also have other features as well, e.g. a digital camera.

It should be noticed that while newer version (e.g. 3GPP SMIL) of MMS SMIL emerge to market, there will be a question about the interoperability between it and the MMS SMIL. As discussed before the basic difference between them is the difference of presentation model and profile. The MMS SMIL, for example, introduces a particular presentation of model “slideshow” which divides the presentation into a series of consecutive slides, each slide containing one image and one text and one audio. The slides define the necessary SMIL elements to realize the presentation model. On the contrary, 3GPP SMIL is a genuine profile which does not imply particular presentation model, but unlimited number of different presentations and variations may occur, including the one defined by MMS SMIL.

The current invention enables that the printable output forms a slide of a slide presentation, wherein it can applied in the conversion of 3GPP SMIL to MMS SMIL. Naturally one printable output forms one slide and many printable outputs form many slides. While considering the conversion of 3GPP SMIL to MMS SMIL it will be clear that exactly same presentation may not result, which can be considered a similar problem than with aforementioned printing of multimedia messages. However, the 3GPP SMIL presentation that is printed according to the invention, is possible to convert to the MMS SMIL presentation using the following additional steps:
a) consider each output 3GPP SMIL page as one MMS SMIL slide
b) convert all images and other media to one single image on each slide
c) construct MMS SMIL presentation based on the created slides.

By this the use of MMS SMIL instead of the 3GPP SMIL is possible.

It will be clear that variations and modifications of the examples of embodiment described are possible without departing from the scope of protection of the invention as set forth in the claims.

1. A method for printing an electronic presentation, the method comprising steps for processing a presentation data, wherein the method comprises steps for forming at least one printable output from said electronic presentation that comprises multiple events, by defining a temporal aspect of said events, whereby the printable output is formed based on said temporal aspect.

2. The method of claim 1 further comprising step for defining a temporal aspect by an onset of each event in the presentation.

3. The method of claim 1, wherein from one to, in maximum, as many printable outputs are formed as there are printable events in the presentation.

4. The method of claim 1, wherein one or more events are located in layout locations of the presentation.

5. The method of claim 4, further comprising steps for studying a spatial aspect of each event by defining the layout location of each event.

6. The method of claim 5, further comprising steps for combining events into single output, if their layout locations differ from another, and otherwise keeping them on separated outputs.

7. The method of claim 6, wherein the single output is printed on a same printout, whereas the separated outputs are printed on their own printouts.

8. The method of claim 1, wherein the presentation is a multimedia message and an event is an appearance of a media object of one of the following group: editable text, non-editable text, image, animation, video, streaming video, audio converted to image or to text.

9. The method of claim 1, wherein the printout is printed to one of the following group: a file, a hard copy.

10. The method of claim 1, wherein the printable output forms a slide of a slide presentation.

11. A device for producing a printable output of an electronic presentation, the device comprising means for processing a presentation data, wherein the device comprises means for forming at least one printable output from said electronic presentation that comprises multiple events, by defining a temporal aspect of said events, whereby the forming of a printable output is based said temporal aspect.

12. The device of claim 11, wherein the temporal aspect is based to an onset of each event in the presentation.

13. The device of claim 11, the device is arranged to form from one to, in maximum as many printable outputs as there are printable events in the presentation.

14. The device of claim 11, wherein said presentation comprises layout locations for one or more events.

15. The device of claim 14, further comprising means for defining the layout location of an event.

16. The device of claim 15, further comprising means for combining events on the one output, if the layout locations of an event differs from the layout location of another object, and otherwise keeping them on separate outputs.

17. The device of claim 11, wherein the presentation is a multimedia message, wherein the device is arranged to process objects from at least one of the following groups: editable text, non-editable text, image, animation, video, streaming video, audio converted to image or text.

18. The device of claim 11, further comprising means for communication through a wireless telecommunications network.

19. The device of claim 11, further comprising a camera.

20. The device of claim 11, further comprising means for displaying the presentation.

21. The device of claim 11, wherein the printout is in one of the following forms: a file, a hard copy.

22. A system for printing an electronic presentation, the system comprising means for processing a presentation data, wherein the system comprises means for forming at least one printable output from said electronic presentation that comprises multiple events, by defining a temporal aspect of said events, whereby the forming of a printable output is based on said temporal aspect.

23. The system of claim 22, further comprising means for defining a layout location of each event in the presentation.

24. The system of claim 22, wherein the system is arranged to combine events on one output, if the layout location of one event differs from the layout location of another event, and otherwise keeping them on separate outputs.

25. The system of claim 22, further comprising means for printing from one to, in maximum, as many printouts as there are events in the presentation.

26. The system of claim 22, further comprising a wireless communication network for transferring the printable output from the means for forming the output to the printing means.

27. The system of claim 22, wherein the printout is one of the following: a file, a hard copy.

28. A device module for producing a printable output of an electronic presentation, the module comprising means for processing a presentation data, wherein the module comprises means for forming at least one printable output from said electronic presentation that comprises multiple events, by defining a temporal aspect of said events, whereby the forming of a printable output is based on said temporal aspect.

29. A computer program product for producing a printable output of an electronic presentation, the computer program comprising instructions for processing a presentation data, wherein the computer program comprises instructions for forming at least one printable output from said electronic presentation that comprises multiple events, by defining a temporal aspect of said events, whereby the forming of a printable output is based on that definition.

30. The computer program product of claim 29 wherein the computer program product is stored on a computer readable storage medium.

31. A method for delivering a printout of an electronic presentation, comprising steps for acquiring a presentation data from a sending device via wireless network, wherein the method comprises steps for forming at least one printable output from said electronic presentation that comprises multiple events, by defining a temporal aspect of events, whereby the forming of a printable output is based on said temporal aspect, and step for printing said printable output, wherein the printout of the electronic presentation is delivered to the recipient and charged from the sender.

32. The method of claim 31, wherein the printout is in one of the following forms: a varying sized paper, a postcard, a fax, a photograph.
